(19) United States
(12) Patent Application Publication
(10) Pub. No.: US 2025/0346770 A1
(43) Pub. Date: Nov. 13, 2025

(54) LUMINESCENT SURFACE COVERING

(71) Applicant: Hyperform, Inc., Rockledge, FL (US)

(72) Inventor: Jason Gardner, Melboume Beach, FL (US)

(21) Appl. No.: 19/236,283

(22) Filed: Jun. 12, 2025

Related U.S. Application Data
(62) Division of application No. 16/654,465, filed on Oct. 16, 2019.
(60) Provisional application No. 62/746,088, filed on Oct. 16, 2018.

(51) Int. Cl. C09D 5/22; C09D 7/61; C09D 163/00

(52) U.S. Cl. CPC C09D 5/22; C09D 7/61; C09D 163/00

(57) ABSTRACT

A photo-luminescent-lighted surface covering for attaching to a surface of a boat including a first layer of material comprising at least one of EVA closed cell foam and PE closed cell foam such that the first layer of material is compressible and flexible, the first layer of material having a non-skid upper surface and a planar bottom surface, a second layer of material comprising at least of EVA closed cell foam and PE closed cell foam, the second layer having a planar bottom surface and an upper surface attached to the bottom surface of the first layer, a first photo-luminescent material mixed into at least one of the first layer of material and the second layer of material, and a channel disposed in the upper surface of the first layer such that the second layer is visible through the channel.

### CROSS-REFERENCE TO RELATED APPLICATIONS

This application is a continuation of U.S. patent application Ser. No. 16/654,465, filed Oct. 16, 2019, entitled “LUMINESCENT SURFACE COVERING,” which claims the benefit of U.S. Provisional Patent Application No. 62/746,088, filed Oct. 16, 2018, entitled “LUMINESCENT SURFACE COVERING,” which are hereby incorporated by reference in their entirety.

### BACKGROUND OF THE INVENTION

### Field of the Invention

The field of the invention relates generally to systems and methods for providing luminescent surface coverings for structures such as boat surfaces, recreational vehicle surfaces, swim spa surfaces, conventional spa surfaces, pool deck surfaces, golf cart surfaces, kayak surfaces, portable cooler surfaces, athletic and sport equipment, goal posts, three and four wheel motorized vehicles, watercraft surfaces, building floors and walls, and any other structure or surface.

### Background Art

Flexible low surface energy substrates, such as, for example, ethylene-vinyl acetate (EVA) foam, are used for numerous applications including marine and other aquatic applications. For example, base materials in the form of traction pads comprising materials such as closed cell EVA foam are applied to boat decks and other boat surfaces such as swim platforms and helm stations, recreational vehicles, golf carts, kayaks, and watercraft to provide a padded, non-skid surface that is comfortable for a user to walk on or to rest against. In many of these applications, the vehicle, boat, recreational vehicle or other structure upon to which the base material is attached are utilized in the darkness of night. In such situations it would be advantageous that the base provide some amount of lighting, without the need for wiring, batteries, electric power-consuming devices which are susceptible to failure due to water intrusion, corrosion, the effects of weather, and other modes of failure. It would be desirable in some applications that the light be of low enough intensity so as to not impair the night vision of the user. This would be the case, for example, in the situation in which the base is applied to the decking of a boat being operated at night. In such a situation it would be desirable that the base provide enough low level light to prevent tripping from fishing or other gear in the boat, but not so much light as to impair the night vision of the operator so that the operator is still able to navigate and to see navigational markers and hazards in the water.

What is needed in the art, therefore, is an apparatus and/or method adapted to providing luminescent surface coverings for boats, recreational vehicles, swim spas, conventional spas, pool decks and surfaces, golf carts, kayaks, watercraft, building floors and walls, and any other structure or surface such that soft low level lighting is provided to a user.

### BRIEF SUMMARY OF THE INVENTION

The present invention comprises an apparatus and method that have one or more of the following features and/or steps, which alone or in any combination may comprise patentable subject matter.

One embodiment as shown and described herein includes a photo-luminescent-lighted surface covering for attaching to a surface of a boat that includes a first layer of material comprising at least one of EVA closed cell foam and PE closed cell foam such that the first layer of material is compressible and flexible, the first layer of material having a non-skid upper surface and a planar bottom surface, a second layer of material comprising at least of EVA closed cell foam and PE closed cell foam, the second layer having a planar bottom surface and an upper surface attached to the bottom surface of the first layer, a first photo-luminescent material mixed into at least one of the first layer of material and the second layer of material, and a channel disposed in the upper surface of the first layer such that the second layer is visible through the channel.

Another embodiment as shown and described herein may further or alternatively include a method of manufacturing a photo-luminescent-lighted surface cover for a both surface that includes providing a first layer of material comprising at least one of EVA closed cell foam and PE closed cell foam, the first layer of material having an upper surface and a bottom surface, providing a second layer of material comprising at least of EVA closed cell foam and PE closed cell foam, the second layer having a bottom surface and an upper surface, providing a first photo-luminescent material that is mixed into at least one of the first layer of material and the second layer of material, and attaching the bottom surface of the first layer to the upper surface of the second layer, and forming a channel in the upper surface of the first layer such that the second layer is visible through the channel.

These and other features, advantages, and objects of the embodiments as disclosed herein will be further understood and appreciated by those skilled in the art by reference to the following specification, claims, and appended drawings.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 depicts a side view of an embodiment of the invention, showing a cross section of the surface covering and various locations for applying a photo luminescent material; and depicting that the surface covering may comprise one or more layers of material.

FIG. 2 depicts an embodiment of the invention, in which the surface covering has been applied to a boat swim platform. The photo luminescent material may be applied in routed areas for providing low level lighting, for providing ornamental features to the surface covering, or for any other purpose.

In the figures, like callouts refer to like features.

### DETAILED DESCRIPTION OF PREFERRED EMBODIMENT

The following documentation provides a detailed description of the invention.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

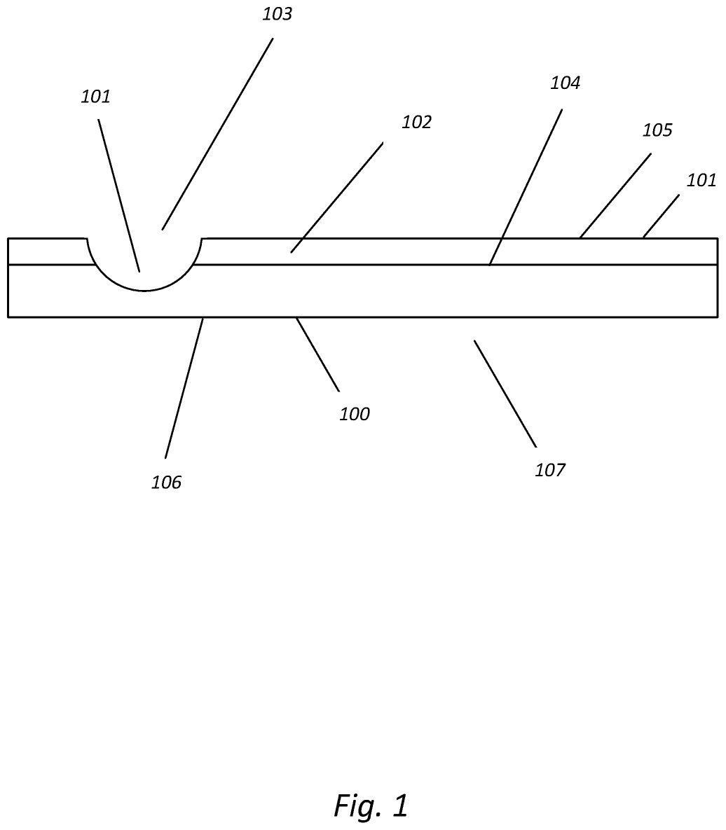

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other characteristics relating to the embodiments disclosed herein are not to be considered as limiting, unless the claims expressly state otherwise.

As used herein, “surface covering” or “traction pad” means any covering that is intended to be attached or applied to any surface to provide a desired effect such cushioning to reduce impact; sound deadening; decoration, texturing or other appearance enhancing features; or any other desired effect. The covering does not have to permanently attach to the structure to which is applied. A surface covering may comprise one or more layers of material, which may be sheet material.

As used herein, “luminescent material”, “glow in the dark material” and “photo-luminescent material” include within their meaning any material that comprises a pigment or material that releases energy in the form of light and may include, for example, photo-luminescent pigments or materials, phosphorescent pigments or materials, fluorescent pigments or materials, chemiluminescent pigments or materials, ultra violet (UV) glow pigments and materials, radioactive materials and any other pigment or material that emits light, using any process, pigment or material known in the art to emit light. “Glow in the dark material” and “photo-luminescent material” also include within their meaning pigments or materials comprising alkaline earth metal aluminate (AEA) made from high purity inorganic materials and doped with “rare earth” metals (lanthanoids); pigments or materials comprising zinc sulfide pigments or materials; pigments or materials comprising zinc sulfide doped with a dopant such as, for example, europium such as in SrA1204:Eu; copper-activated zinc sulfide pigments or materials, pigments or materials comprising copper-activated zinc sulfide doped with a dopant such as, for example, europium such as in SrA1204:Eu; strontium aluminate pigments or materials; pigments or materials comprising strontium aluminate oxide doped with rare earth impurities such as Europium; pigments or materials comprising strontium aluminate known as SRA, SrA1, or SrA1204; radium pigments or materials; tritium pigments or materials; pigments or materials comprising barium sulfide; or any other material that emits light. Thus the definition of glow in the dark materials includes pigments or materials that emit light when mixed with other materials such as in glow sticks; pigments or materials that emit light for a period of time after being charged from a light source by being exposed to a light source such as for example any light source, sunlight, or an UV lights such as a black light; ultra violet (UV) glow pigments and materials that glow, or emit light in the visible spectrum, when subjected to UV light such as a black light; and pigments or materials that emit light through spontaneous radiation such as radium Examples of ultra violet (UV) glow pigments and materials include but are not limited to UV phosphorous pigments or materials, which may emit any wavelength of visible light including but not limited to 450 nm, 420 nm, 505 nm, 510 nm, 545 nm, 590 nm, 615 nm, 500 nm, or 595 nm. “Glow in the dark material” and “photo-luminescent material” also include within their meaning rare earth-alkaline mineral crystals. In an embodiment, “luminescent”, “glow in the dark materials” and “photo-luminescent materials” may be free from radioactive additives. In an embodiment, “luminescent”, “glow in the dark materials” and “photo-luminescent materials” may be re-charged an infinite number of times. In an embodiment, “glow in the dark materials” and “photo-luminescent materials” may be toxicologically harmless.

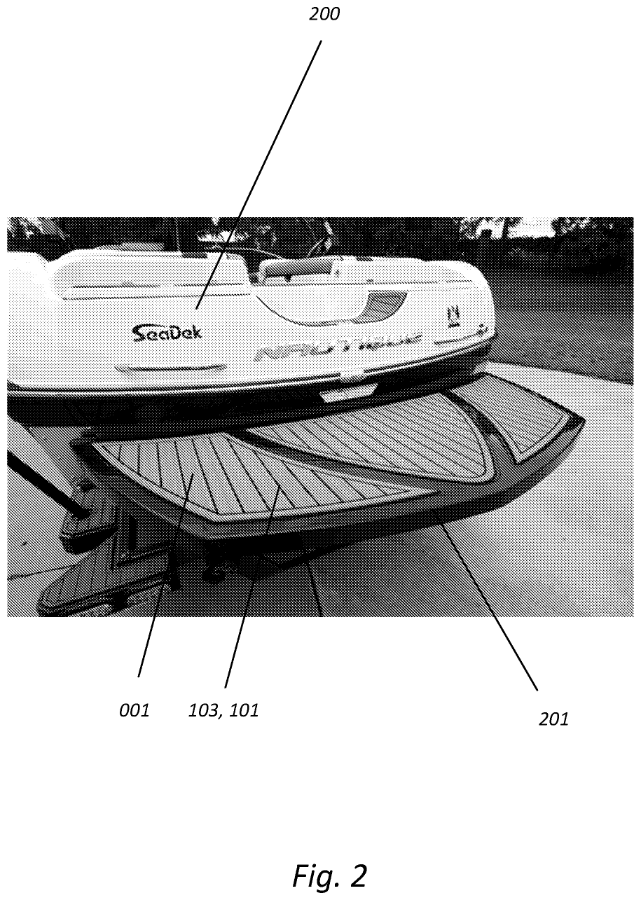

Referring now to FIGS. 1 and 2, a cross section view of an embodiment of the invention is depicted. A surface covering 001, which may be a traction pad or deck pad installed on a boat surface for providing traction, reducing impact i.e. cushioning or absorbing shock, or for decoration may be comprised of at least one layer of material or a plurality of layers of material. In the embodiment shown in FIG. 1, base 001 is depicted as comprising two layers of material, first layer of material 102 and second layer of material 108, which may be attached to one another at boundary surface 104 by any means known in the art, for example and not by way of limitation, chemical bonding using an adhesive or heat lamination. A portion 103 may be routed in the surface covering. In the exemplary, non-limiting depiction of the two-layer base shown in FIG. 1, the routed portion is shown as extending through first layer of material 102 and into second layer of material 108. Such routing may be advantageous, for example, if first layer 102 and second layer of material 108 are each of a different color. In such case, the routing through first layer of material 102 exposes may expose the color of second layer of material 108 creating a visible pattern as seen from the direction of 103. In practice, base 001 may comprise any number of layers of material. First layer of material 102 may have an upper, visible surface 105 when base 001 is attached to a boat or other structure 107 at surface 100. In an embodiment, the glow in the dark material or photo-luminescent material 101 may be applied to upper surface 105 of first layer of material 102 to create any glow in the dark or photo-luminescent pattern desired.

Referring now to FIG. 1, a glow in the dark material or photo-luminescent material 101 may be deposited in the route 103. The glow in the dark material or photo-luminescent material 101 may cover any portion of route 103; i.e., either leaving some of route second layer of material 108 showing in route 103, or covering up second layer 108 altogether such that second layer of material 108 is not visible as seen from the direction of 103.

The glow in the dark material or photo-luminescent material 101 may be deposited directly onto any surface of the surface covering, such as visible surface 105, or may be included in the material of the surface covering itself at time of manufacture such as, in the case of EVA foam, in the mixing of the chemical composition that is used to create, or “blow”, the EVA closed cell foam material.

A surface covering of the invention may attach to a surface of a structure using chemical bonding (i.e. adhesive) which, in embodiments, comprise an adhesive film, or by using at least on snap that forms a part of a mating snap pair captured in the surface covering, which is adapted to be received by at least one complementary snap receiving structure forming a second part of the mating snap pair which is attached to a surface upon which is desired to attach the surface covering of the invention. The invention may comprise any number of snaps for attaching to such surface.

Referring now to FIG. 2, an embodiment of the invention is depicted in which a deck pad of the invention has been applied to the swim platform 201 of a boat 200. It can be seen in FIG. 2 that the routed areas 103 may be used form any pattern or decorative configuration desired, thus providing a glowing pattern or decorative configuration when glow in the dark material or photo-luminescent material 101 is deposited in the route 103. When the glow in the dark material or photo-luminescent material 101 has been charged, a low level glow of light will appear in the shape of 103, which may take any shape or configuration desired by the user. This would have significant advantage for a night user of the swim platform, providing an extra measure of safety in order to prevent a user from accidentally falling off the swim platform due to a misstep in the darkness.

In an embodiment, the glow in the dark material or photo-luminescent material 101 may be mixed with a bonding agent such as, for example, an epoxy, prior to being applied to route 103 or to the upper surface 105 of first layer of material 102. The use of the bonding agent may provide additional chemical bonding of the glow in the dark material or photo-luminescent material 101 to the base layers of material. This additional bonding is useful to prevent the glow in the dark material or photo-luminescent material 101 from wearing off, or being removed, due to normal use, wear and tear, weather or washings of the surface to the base is attached. The bonding agent may be a clear casting epoxy resin or coating epoxy resin.

In embodiments, any visible surface of a surface covering of the invention may comprise texturing such as, for example, a brushed texture, a pattern-embossed texture, a smooth texture, a cross-brushed texture, a grooved texture or any other texture that comprises modification of the visible surface by milling, heating, brushing, embossing or any other process.

In embodiments, the photo-luminescent material 101 may form designs, lettering, logos, patterns, or any other desired informational or decorative pattern or shape in the layer of material upon which is applied. For example, a company brand or logo may be formed by the application of the photo-luminescent material 101 in a surface covering of the invention for advertising or branding purposes.

The invention may comprise a method of manufacturing a photo-luminescent surface covering, comprising providing a first layer of material; providing a second layer of material; attaching the first layer of material and the second layer of material at a boundary between them; routing a route, or cutout, through the first layer of material and into the second layer of material; mixing a photo-luminescent with a bonding agent to create a photo-luminescent mixture; and depositing the photo-luminescent mixture into the route or cutout. In an embodiment, the first layer of material and said second layer of material may be EVA or PE foam In an embodiment, the step of attaching may be further defined as being selected from the group consisting of chemical bonding or heat lamination. In an embodiment, the step of attaching may be further defined as being selected from the group consisting of chemical bonding or heat lamination. The photo-luminescent material may be further defined as comprising a rare earth metal. The method of the invention may also further include the step of forming a company identifier, such as a trademark or logo, on the surface or surfaces to which the photo-luminescent material is applied or routing a company identifier, such as a trademark or logo, on a surface of the surface covering.

In an embodiment, the first layer of material may be characterized has comprising a first color, and said second layer of material is characterized has comprising a second color.

In embodiments, a method of the invention may further comprise the step of attaching a photo-luminescent surface covering of the invention to one of a surface of a marine product, a surface of a spa cabinet, a surface of a pool, a surface of a portable cooler, a surface of a golf cart, or a surface of a swim spa.

In an embodiment, base 001 may comprise at least one layer of material, but may also comprise a plurality of layers of material. The layers of material may comprise flexible low surface energy substrates, such as, for example, closed cell ethylene-vinyl acetate (EVA) foam or closed cell Polyethylene (PE) foam, such as are used for numerous applications including marine and other aquatic applications. The photo luminescent system and method described and claimed herein is not limited by the type of material comprising the layer(s) of material of the surface covering.

The invention claimed is:

1. A photo-luminescent-lighted surface covering for attaching to a surface of a boat, comprising:
a first layer of material comprising at least one of EVA closed cell foam and PE closed cell foam such that the first layer of material is compressible and flexible, the first layer of material having a non-skid upper surface and a planar bottom surface;
a second layer of material comprising at least of EVA closed cell foam and PE closed cell foam, the second layer having a planar bottom surface and an upper surface attached to the bottom surface of the first layer;
a first photo-luminescent material mixed into at least one of the first layer of material and the second layer of material; and
a channel disposed in the upper surface of the first layer such that the second layer is visible through the channel.

2. The photo-luminescent-lighted surface cover of claim 1, wherein the photo-luminescent material is mixed into the first layer of material.

3. The photo-luminescent-lighted surface cover of claim 2, further comprising:
a second photo-luminescent material mixed into the second layer of material.

4. The photo-luminescent-lighted surface cover of claim 3, wherein the second photo-luminescent material is the same as the first photo-luminescent material.

5. The photo-luminescent-lighted surface cover of claim 1, wherein the first photo-luminescent material comprises a rare-earth metal.

6. The photo-luminescent-lighted surface cover of claim 1, wherein the first layer of material comprises a first color and the second layer of material comprises a second color that is different from the first color.

7. The photo-luminescent-lighted surface cover of claim 1, wherein the channel is routed into the first layer of material.

8. The photo-luminescent-lighted surface cover of claim 1, further comprising:
an adhesive covering at least a portion of the bottom surface of the second layer.

9. The photo-luminescent-lighted surface cover of claim 1, wherein the non-skid upper surface is textured.

10. The photo-luminescent-lighted surface cover of claim 1, wherein the channel extends into the second layer of material.

11. A method of manufacturing a photo-luminescent-lighted surface cover for a boat surface, comprising:
providing a first layer of material comprising at least one of EVA closed cell foam and PE closed cell foam, the first layer of material having an upper surface and a bottom surface;
providing a second layer of material comprising at least of EVA closed cell foam and PE closed cell foam, the second layer having a bottom surface and an upper surface;
providing a first photo-luminescent material that is mixed into at least one of the first layer of material and the second layer of material;
attaching the bottom surface of the first layer to the upper surface of the second layer; and
forming a channel in the upper surface of the first layer such that the second layer is visible through the channel.

12. The method of claim 11, wherein the first layer of material is compressible and flexible.

13. The method of claim 11, wherein the bottom surface is the first layer is laminated to the upper surface of the second layer.

14. The method of claim 11, wherein the upper surface of the first layer is provided a no-skid texture.

15. The method of claim 11, wherein the photo-luminescent material is mixed into the first layer of material.

16. The method of claim 15, further comprising:
providing a second photo-luminescent material mixed into the second layer of material.

17. The method of claim 11, wherein the second photo-luminescent material is the same as the first photo-luminescent material.

18. The method of claim 11, wherein the first photo-luminescent material comprises a rare-earth metal.

19. The method of claim 11, wherein the first layer of material comprises a first color and the second layer of material comprises a second color that is different from the first color.

20. The method of claim 11, wherein forming the channel includes routing the channel in the upper surface of the first layer of material.

21. The method of claim 11, further comprising:
providing an adhesive covering at least a portion of the bottom surface of the second layer.

22. The method of claim 11, wherein forming the channel includes extending the channel into the second layer of material.
